(19) United States
(12) Patent Application Publication
(10) Pub. No.: US 2016/0214871 A1
(43) Pub. Date: Jul. 28, 2016

(54) Radon Separating Drainage Pipe Termination

(71) Applicant: Sam Lee, Naperville, IL (US)

(72) Inventor: Sam Lee, Naperville, IL (US)

(21) Appl. No.: 14/605,810

(22) Filed: Jan. 26, 2015

(51) Int. Cl. C02F 1/20; B01D 19/00

(52) U.S. Cl. CPC C02F 1/20; B01D 19/0073; C02F 2101/006

(57) ABSTRACT

A manifold used to terminate drainage pipes within sump basins designed to separate and remove gasses, including radon. The device provides a physical termination for a drainage pipe within the sump basin and has at least one dedicated exit for the gasses and at least one dedicated exit for the ground water and other drainage material that emanate from said drainage pipe. The exit from which gas emanates can be connected to vent pipes where any dangerous gasses, such as radon, can be directed away. The invention enables the lowering of radon levels within building structures by diverting the gasses emanating from drainage pipes within a sump basin without requiring the entire sump basin to be sealed, allowing easier inspection and maintenance of the equipment within the sump basin. Another key goal of this invention is to allow radon mediation utilizing an existing sump basin without the need to replace or retrofit the entire said sump basin.

### BACKGROUND OF INVENTION

1. Technical Field

This invention relates to sump basin drainage and radon removal systems.

2. Background Art

Radon mitigation in residential and commercial buildings comes in numerous forms. A typical sump basin based radon extraction system is shown in FIG. 1. Methods to remove radon from building structures range from simply venting with an exhaust fan to applying elaborate systems to actively depressurize the ground areas surrounding the building structure (references, U.S. Pat. No. 4,988,237 Crawshaw; U.S. Pat. No. 4,957,394 Jarnagin et al.; U.S. Pat. No. 5,101,712 Dean, Jr.).

Radon 1 is a cancer causing, radioactive gas that comes from the decay of uranium found in igneous rock, soil and water. Exposure to radon gas puts individuals at an increased risk of lung cancer. Next to smoking, it is the second leading cause of lung cancer in the United States estimated at as many as 20,000 deaths per year. Because it has no smell or taste, the presence of radon may go undetected for an extended period of time until a radon specific test is done. Due to radon's high density, making it much heavier than air, exposure in lower levels of dwellings and work environments is a major concern worldwide.

Radon entry into inhabited spaces is typically via cracks and other openings in the lowest levels of buildings 2 which are in contact with soil 9, rock 8 or ground water. In many residential dwellings, a ground water collection system utilizing an underground level basin or sump 3 is used to hold rain and standing water. These sump based systems collect water from around and under the building foundation using a system of buried drainage pipes 4, 5. These same drainage pipes also serve as a conduit for the natural radon gas 1 into buildings from the adjacent grounds. Radon gas is facilitated into a building by the lower internal pressures created by ventilation systems and the natural updraft of warm air within the building.

Often, the sump basin 3 where drainage pipes terminate is a natural location to collect radon for removal from a building. Various types of systems have been devised to extract the radon gas from the sump basin. The gasses collected by these systems are drawn away via pipes 11 connected to commercially available radon extraction fans 10.

Another common radon extraction system utilizes direct subterranean depressurization where a vacuum is created directly beneath or near the building structure in order to remove the surrounding radon. In this type of system, a hole is drilled into the ground or floor of the lowest level, a volume of ground material is dug out and a vacuum pipe is used to draw out the radon from beneath the building and surrounding grounds (references, U.S. Pat. No. 4,988,237 Crawshaw; U.S. Pat. No. 5,101,712 Dean, Jr.; U.S. Pat. No. 5,013,183 Erikson et al.; U.S. Pat. No. 5,083,500 Francis et al.).

Various new building construction methods have also been proposed to isolate radon for extraction. These include double hull construction (reference, U.S. Pat. No. 7,181,888 Facaros) as well as specialized drainage systems (reference, U.S. Pat. No. 5,694,723 Parker; U.S. Pat. No. 5,277,003 Myers; U.S. Pat. No. 8,544,219 Janesky; U.S. Pat. No. 5,474,400 Kliefoth). Additionally, radon barriers beneath new construction (reference, U.S. Pat. No. 6,676,780B1 Shahar) have been proposed to prevent radon penetration.

### BRIEF SUMMARY OF INVENTION

### Technical Problem

Different sump basin based radon mitigation systems have been proposed. The most common types utilize air tight covers with seals 7 around the entire sump basin as well as seals for all protrusions from pumps, wiring and appliance drainage plumbing (references, U.S. Pat. No. 8,474,477B1 Melisz Jr.; U.S. Pat. No. 4,890,425 Mamula; U.S. Pat. No. 6,276,093B1 Janesky; D706,8345 Nowicki et al.; U.S. Pat. No. 6,524,182B2 Kilburn et al.; U.S. Pat. No. 8,117,797B2 Andras). To achieve an effective gas seal, customization is often required for each specific installation. As the number and size of the protrusions increase, greater customization skill is required to create an air tight cover. Large sump enclosures (reference, U.S. Pat. No. 4,949,626 Townsend et al.) have also been used to confine the radon gas to the sump basin with similar issues as the sealed sump basin covers.

Often these customized sump basin covers require fastening mechanisms as well as additional caulking to create an air tight seal. These fasteners and sealants make it harder to remove the cover for maintenance.

Alternatively, plenum chambers have also been proposed (reference, U.S. Pat. No. 5,836,815 Jennemann) to collect radon gas in sump basins for extraction. These plenum chambers also require an air tight seal to be created between the main sections of the chamber as well as customized openings for each drainage pipe entering the sump area.

Both sealed sump basin cover as well as plenum chamber based radon mitigation systems often require significant customization to implement effectively. Additionally, both types limit visibility of, as well as accessibility to, the equipment within the sump basin or the drainage pipes entering into the sump basin.

### Solution to Problem

As demonstrated by one or more of the embodiments, this invention relates to devices that separate the gasses from the ground water discharged from drainage pipes within sump basins. The invention provides a physical termination for the drainage pipe 200 within the sump basin, has at least one dedicated exit 103, 304 for the gasses and at least one dedicated exit 105, 307 for the ground water that emanate from said drainage pipe. The exit port 104, 305 from which gas emanates can be connected to vent pipes where any dangerous gasses such as radon can be expelled away from the inhabited interior spaces 12. The separation of the gasses from ground water can be accomplished by different means. The example embodiments described here demonstrate some of the different methods which can be used to separate the gas from the ground water emanating from a drainage pipe 200.

In one maintenance free embodiment of the invention 100 (Embodiment A), no moving parts are utilized. Ground water emanating from the drainage pipe forms a seal 112 at the bottom exit 105 of the device preventing the gasses from leaving along with the expelled ground water thus effectively separating out the gaseous emissions. The diverted gasses, including any radon, leave at the upper exit 103 of the device. Additional negative pressure can be applied to the gas exit 103 of the device using commercially available products, such as radon evacuation fans 10, connected through vacuum pipes 11 which lead away from the inhabited spaces 12. An additional benefit is that any radon dissipated from splashing ground water 202 is captured and removed by this embodiment.

A more space efficient, minimally intrusive, embodiment of the invention 300 (Embodiment B), utilizes a combination gas-liquid check valve 303 to allow ground water to be expelled while preventing gasses from escaping into the sump basin. This combination check valve is opened by the fluid pressure exerted by the ground water flowing out of the device 203. While the check valve is open, a small negative pressure can be applied to prevent any gasses from leaking out into the sump basin. When no ground water is emanating from the drainage pipe, this check valve 303 is completely closed, channeling any gas vapors to the gas opening 304 of the device. Although the check valve 303 adds complexity to the design when compared to the maintenance free embodiment 100, the form factor can be more compact and thus allow fitment into more congested sump basin configurations.

### Advantageous Effects of Invention

The invention enables the lowering of radon levels within residential and commercial structures by diverting the gasses emanating from drainage pipes within the sump basin without requiring the entire sump basin to be sealed. An open sump basin makes it easier to inspect and maintain the equipment within said sump basin.

For the purposes of this discussion, the term “ground water” 201 refers to any non-gaseous material emanating from drainage pipes. This includes rain water as well as sediment and other impurities.

### BRIEF DESCRIPTION OF DRAWINGS

FIG. 1 Sump Basin Radon Removal System—Prior Art

FIG. 2 Radon Separating Drainage Pipe Termination—Radon Removal System

FIG. 3 Radon Separating Drainage Pipe Termination—Embodiment A

FIG. 4 Embodiment A—Cylindrical Body Variation

FIG. 5 Embodiment A—Rectangular Body Variation

FIG. 6 Embodiment A—Custom Body Variation

FIG. 7A, 7B Radon Separating Drainage Pipe Termination—Embodiment B, Compact Form Factor

FIG. 8A Embodiment A—Perspective View in Sump Basin

FIG. 8B Embodiment A—Cross Sectional View in Sump Basin

FIG. 9A Embodiment B—Perspective View in Sump Basin

FIG. 9B Embodiment B—Cross Sectional View in Sump Basin

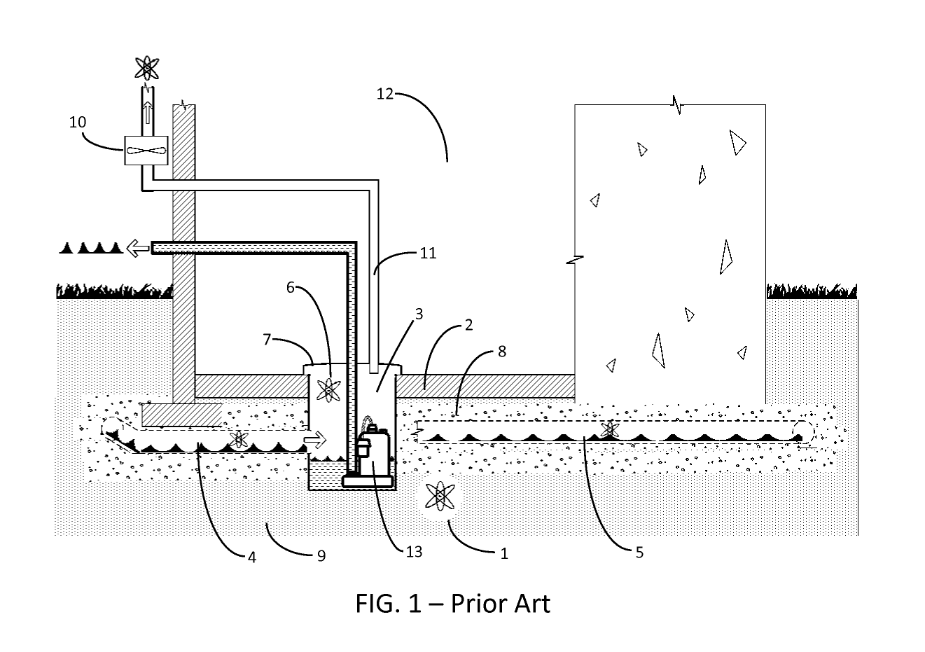

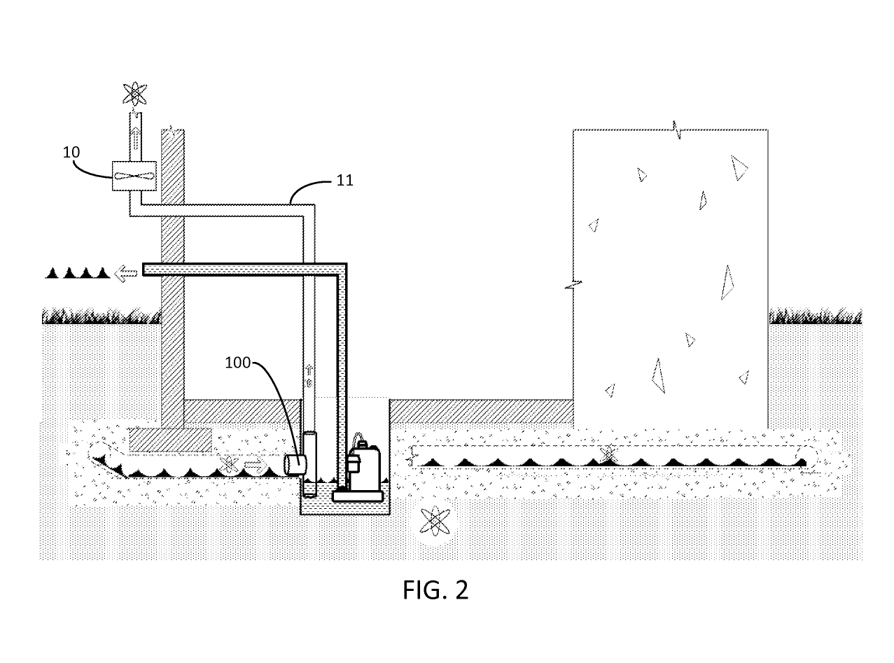

### DETAILED DESCRIPTION OF INVENTION

The invention is not limited to the embodiments described in the text and associated drawings. There are many alternate forms of the embodiment. Any suitable size, shape or type of materials can be used to implement this invention.

### Description of Embodiments

As demonstrated by one or more of the embodiments, this invention relates to devices that separate the gasses 6 from the ground water 201 discharged from drainage pipes 200 in sump basins 3. The invention physically terminates the drainage pipe 200 within the sump basin 3 and has at least one dedicated exit for the gasses 103, 304 and at least one dedicated exit for the ground water 105, 307 that emanate from said drainage pipe. The device is suitable for installation onto existing drainage pipe terminations 200 or, alternatively, can be included with new drainage pipe terminations at sump basins 3. The method by which the gasses and ground water are separated can vary with different embodiments. Several of these methods are described by, but not limited to, the embodiments described here.

### EXAMPLE 1

### Maintenance Free Embodiment (Embodiment A)

In this embodiment, simplicity is the priority. The embodiment consists of effectively a sideways “T” shaped manifold 100 with three ports. The center port 102 attaches to the drainage pipe outlet. This center port 102 is also where ground water and gasses enter the device. The top port 104 is where gasses exit while the bottom port 106 is where the ground water exits. Once installed, there are no moving parts in this embodiment contributing to maintenance free operations.

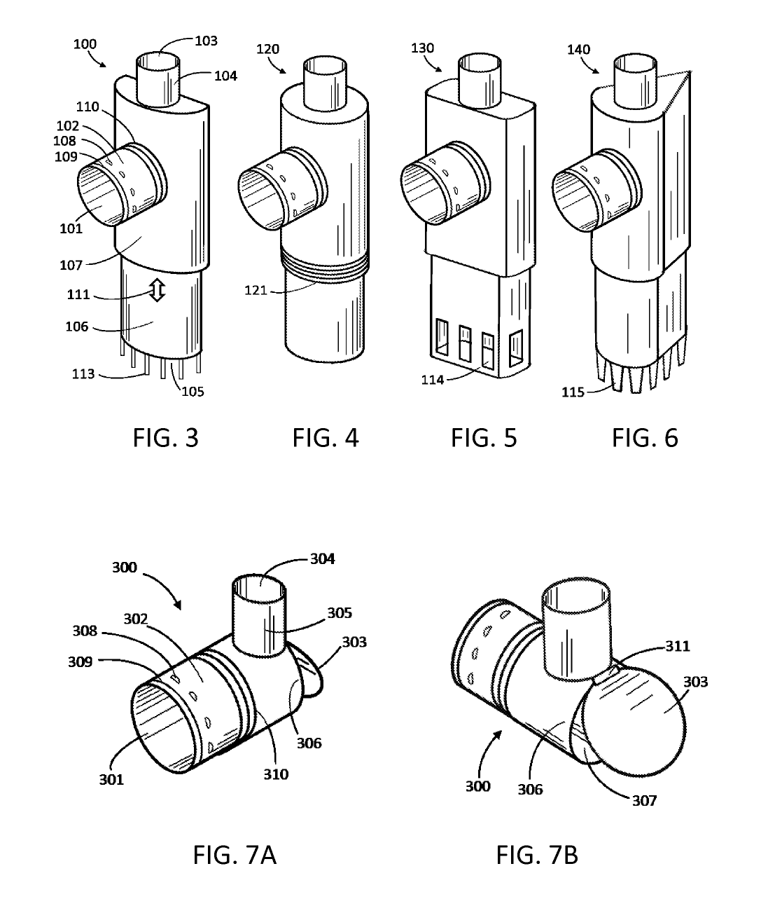

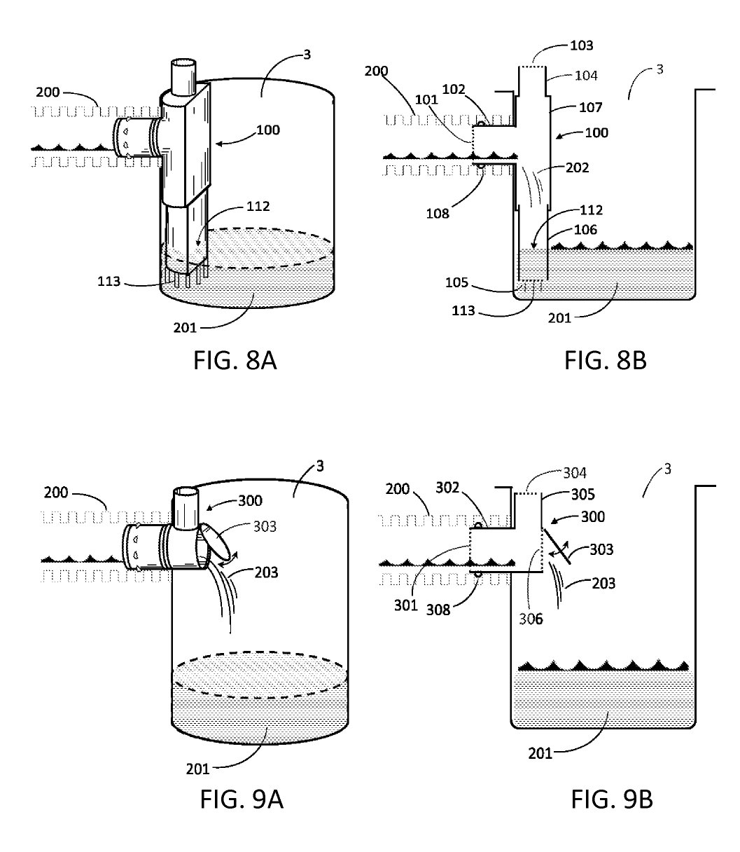

In this embodiment, the center port 102 is attached to the terminating end of the drainage pipe 200 using a friction fit principle. This center port 102 is made to fit snuggly into the drainage pipe opening 200. If the drainage pipe 200 has a corrugated surface, small protrusions 108 can be added to this center port 102 to hold onto the corrugations preventing movement once the device is inserted. Alternatively, adhesives, clamping mechanism, rivets and other mechanical methods can also be utilized to securely fasten the embodiment FIG. 3 to the drainage pipe 200. To further ease the installation process, the center port 102 can be made to be flexible 110 as well as detachable from the main manifold body 107 so it can be secured onto the drainage pipe first before mounting of the entire device. An optional sealing gasket 109 can be incorporated onto this center port 102 in order to prevent drainage materials from leaking from the drainage pipe 200 directly into the sump basin 3.

The top port 104 of this embodiment is designed to facilitate the removal of radon and other gasses emanating from the attached drainage pipe 200. Ideally, this port is attached to conduits which lead away from the occupied internal areas of the building structure 12 and may be connected to commercially available evacuation fans 10. These evacuation fans create negative pressure and come in various power levels.

The bottom port 106 of this embodiment is designed to facilitate the removal of ground water from the attached drainage pipe 200. As gas and ground water is expelled from the drainage pipe 200, the embodiment FIG. 3 utilizes gravity to route the water to the bottom port 106 of the device. Any ground water is expelled from the bottom port 106 into the sump basin 3 for extraction by typical means such as with commercially available sump pumps 13. To prevent the bottom port 106 from expelling gasses emanating from the drainage pipe as well as the entrance of any gasses from the sump basin back into the device, a liquid seal 112 is utilized. This liquid seal is formed by the standing ground water within the sump basin surrounding the bottom port. For the liquid seal 112 to function, this ground water exit 105 of this bottom port 106 must be positioned lower than the lowest water level typically reached within the sump basin while still allowing adequate space for the flow of expelled ground water into the sump basin. To facilitate the positioning of the bottom port to the desired location, a telescoping design 111, adjustable shapes 121, stand offs 113, 114, 115, trimmable materials or other methods can be used.

In many cases, the lower port location can be established by measuring the low water level just after ground water evacuation by the sump system's normal water removal cycle. The relatively large water volume held in typical sump basins 3 helps prevent it from drying out and allows this embodiment to be utilized in many residential and commercial buildings. However, in the event that this liquid seal 112 is not possible due to low water levels in the sump basin 3, a negative pressure applied at the invention's gas exit port 104 prevents egress of undesirable gasses such as radon into the sump basin 3. Alternatively, a mechanical check valve at this ground water exit port 106 can be incorporated.

The manifold body of this embodiment can be any suitable shape to facilitate placement into sump basins 3. In this embodiment 100, the manifold body 107 is shaped to hug the curved shaped wall of the sump basin 3. Other shapes such as rectangular tubes 130, cylindrical tubes 120 and custom contoured tubes 140 are also possible and can be applied depending on the spacing needs within the sump basin 3.

### EXAMPLE 2

### Compact Embodiment (Embodiment B)

Often the sump basin 3 is a congested area due to the presence of numerous devices in a confined space. These devices include primary and backup ground water evacuation equipment such as sump pumps 13, water level sensing switches, drainage pipes, pipes to expel ground water, wiring for the electrical devices, check valves, pipe joint connectors, traps etc. A minimally intrusive design is preferred or even required for retrofitting into situations where space is limited. In this embodiment, the drainage water exit port is combined with the manifold body to form a compact example of the invention.

This embodiment of the invention utilizes a combination gas-liquid check valve 303 which allows ground water to be expelled while preventing the gas from escaping into the sump basin 3. The degree that this check valve 303 opens is governed by the amount of ground water emanating 203 from the drainage pipe. The check valve 303 opening increases as the ground water 203 flowing out of the drainage pipe increases. When no ground water is emanating from the drainage pipe 200, this check valve 303 is completely closed, channeling any gas vapors to the gas exit 304 of the device. To prevent gasses from leaking out into the sump area 3 when the check valve 303 is open, a light negative pressure source can be applied to the gas exit port 305. In this embodiment of the invention, the amount of negative pressure can be in the range of 0.5 water column (i.e. approximately 0.018 psi) and can come from commercially available radon evacuation fans 10. This negative pressure serves three purposes: it draws any gasses emanating from the drainage pipe 200, such as radon 1, away from the sump area 3; keeps the gas-liquid check valve 303 closed when no ground water 203 is emanating from the drainage pipe and; prevents any gases from leaking out to the sump area 3 when the valve 303 is open.

The check valve 303 can be made with any suitable waterproof material such as plastic or rubber and must be light enough to be opened by the pressure of the ground water 203 being expelled from the drainage pipe 200. It also has to close when no ground water 203 is coming out of the drainage pipe 200. The closing action can be performed by numerous methods including gravity, spring action, magnetism or the suction created from negative pressure systems such as commercially available radon evacuation fans 10. A simple low friction hinge 311 design can be integrated into the valve and body surface. If the check valve is made from a soft flexible material such as rubber, the hinge can be fabricated by bonding a small extension tab from the check valve directly on to the body surface of the device.

The combination gas-liquid check valve reduces the amount of space taken up by the embodiment 300 inside the sump basin 3 as compared to the maintenance free embodiments FIG. 3, FIG. 4, FIG. 5, and FIG. 6 described earlier. This is because the ground water exit port 306 is built into the manifold body since a liquid seal 112 is not needed, thus eliminating the need for said ground water exit port to reach below the low water level within the sump basin 3.

### EXAMPLE 3

### Multiple Drainage Pipe Terminations

Multiple drainage pipes typically terminate within sump basins 3. The configuration of these drainage pipe terminations are often unique and vary in position (relative to each other as well as height and entrance angle) and size within the sump basin 3. Thus, multiple instances of the invention can be installed within the same sump basin 3, with each instance adjusted to the specific requirements of the individual drainage pipe 200 being terminated. However, the multiple instances may share a singular negative pressure source, for example coming from a single radon exhaust fan 10, for the building.

One method for distributing a singular negative pressure source to multiple instances of this invention is a vacuum distribution block with the appropriate port sizes for each connection. Alternatively, in cases where there are a small number of drainage pipe terminations, in-line “T” connectors on the vacuum pipes 11 can be utilized.

Additionally, an embodiment with multiple input ports can be used to terminate multiple drainage pipes within a sump basin to accomplish the same goals as with multiple, individual embodiments.

For the purposes of this description, the term “ground water” refers to any non-gaseous material emanating from drainage pipes. This includes rain water as well as sediment and other non-gaseous impurities.

What is claimed is:

1. A manifold designed to separate the gasses from the other constituents emitted from drainage pipes in sump basins comprising of:
a manifold body which fits into said sump basin,
an entrance port which attaches to and accepts drainage constituents from a drainage pipe,
an exit port where gasses, received from the entrance port, are expelled,
an exit port where ground water, received from the entrance port, is expelled.

2. The manifold of claim 1 where the ports can be combined with the manifold body itself forming a compact form factor embodiment of the invention.

3. The manifold of claim 1 including a method, to physically stabilize the invention within the sump basin so that the invention can perform its function without preventing other devices, such as sump pumps, within said sump basin from performing their functions, allowing installation into existing as well as new sump basins.

4. The fastening method of claim 3 utilizing: a friction fit principle in order to fit snuggly onto a drainage pipe opening; protrusions on the entrance port to hold onto the drainage pipe corrugations securing the invention to the drainage pipe; adhesives; fusion; clamping mechanisms; rivets; magnets; other physical methods to securely fasten the invention within the sump basin.

5. The manifold of claim 1 incorporating an optional detachable drainage entrance port designed to be installed onto the drainage pipe before mounting of the manifold body in order to ease the installation process.

6. The manifold of claim 1 incorporating an optional flexible drainage entrance port allowing the manifold body position to be adjusted relative to the drainage pipe, facilitating attachment of the invention to drainage pipes which enter the sump basin at various angles.

7. The manifold of claim 1 incorporating one or more optional sealing gaskets to prevent leakage of drainage gasses into the sump basin.

8. The manifold of claim 1 where a liquid seal, formed from the standing ground water held in the sump basin, is utilized to prevent the escape of gasses into the sump basin as well as the entrance of any gasses from the sump basin back into the manifold.

9. The manifold of claim 8 where negative gas pressure is applied in order to prevent leakage of undesirable gasses such as radon into the sump basin in the event that the liquid seal is not possible due to low ground water levels in the sump basin.

10. The manifold of claim 8 where the positioning of the ground water exit port opening is adjustable to the desired location using flexible, extendable shapes and trimmable materials allowing easy positioning beneath the low water level typically reached within the sump basin.

11. The manifold of claim 8 where a stand-off type mechanism, such as protrusions or openings on the ground water exit port, used to prevent the ground water exit port from being positioned too low in the sump basin, restricting the flow of ground water emanating from the attached drainage pipe.

12. The manifold of claim 1 where different shapes, such as rectangular tubes, cylindrical tubes and custom contoured tubes, may be used for the manifold body and ports to facilitate placement into sump basins due to spacing and physical configuration needs.

13. The manifold of claim 1 utilizing a combination gas-liquid check valve, which degree of opening is governed by the amount of out flowing drainage water, allowing ground water to be expelled while preventing excessive drainage gasses from escaping into the sump basin.

14. The manifold of claim 13 utilizing negative pressure to: draw any gasses emanating from the drainage pipe, such as radon, away from the sump area; keep the gas-liquid check valve closed when no ground water is emanating from the drainage pipe and;
prevent any gases from leaking out to the sump area when said check valve is open.

15. The check valve of claim 13 made with any suitable waterproof material and is light enough to be opened by the pressure of the ground water being expelled from the drainage pipe.

16. The check valve of claim 13 utilizing a simple, low maintenance and low friction hinge design which can be integrated into the valve and manifold surface.

17. The check valve of claim 13 utilizing different means including gravity, spring action, material memory, magnetism or negative pressure to maintain a closed position, preventing drainage gasses from leaking into the sump basin, when no ground water is emanating from the attached drainage pipe(s).

18. The manifold in claim 1 applied a plurality of instances within the same sump basin, one for each drainage pipe terminating within said sump basin.

19. The manifolds in claim 18 each connected to the same negative pressure source to remove radon from multiple drainage pipes terminating in the sump basin.
